(19) United States
(12) Patent Application Publication
(10) Pub. No.: US 2025/0131425 A1
(43) Pub. Date: Apr. 24, 2025

(54) EPHEMERAL DYNAMICALLY LINKED MESH NETWORK

(71) Applicant: Wells Fargo Bank, N.A., San Francisco, CA (US)

(72) Inventors: Ryan Hammond, San Francisco, CA (US); Sadie S. Salim, Mill Valley, CA (US); Dennis E. Montenegro, Concord, CA (US)

(21) Appl. No.: 18/053,999

(22) Filed: Nov. 9, 2022

(51) Int. Cl. G06Q 20/40; G06Q 20/38

(52) U.S. Cl. CPC G06Q 20/401; G06Q 20/381

(57) ABSTRACT

Systems and methods for establishing a secure and private local network with a block chain record are disclosed. One disclosed method includes establishing a network connection between a first device, second device, and third device. The method includes configuring a local network in communication with the first device, second device, and third device and establishing a block chain between the first, second, and third devices. The first, second, and third devices are nodes of the block chain and execute consensus protocols to maintain consistency of the block chain. Messages sent between the devices on the local network are stored in the block chain and when the local network is disbanded, the devices upload the block chain to a cloud repository.

### FIELD OF TECHNOLOGY

The present disclosure generally relates to local networks and block chain technology, and more particularly to systems and methods for using local networks and block chain technology to transmit and store information between devices.

### BACKGROUND

Phones and other devices have become increasingly reliant on internet connection to receive and transmit information. When devices lose connection to the internet, the devices may lose their ability to communicate to other devices. Even devices configured to communicate to other devices directly without using the internet lack a secure record of communications. When records differ between devices communicating directly, the devices may be unable to discern between the correct record and errors in the record. Thus current devices are poorly equipped to communicate important information, such as transactional information, directly to other devices.

### SUMMARY

According to certain embodiments, a method for an ephemeral dynamically linked mesh network may comprise: establishing a network connection between a first device and a second device; establishing a network connection between a third device and one or more of the first device and second device; configuring a local network in communication with the first device, second device, and third device; establishing a block chain between the first device, second device, and third device, wherein each of the first device, second device, and third device are nodes of the block chain; transmitting a message from the first device to the second device and the third device; storing in the block chain the message between the first device, second device, and third device; disbanding the local network; and uploading the block chain to a cloud repository. The method may further comprise: connecting a fourth device to the local network; downloading the message stored to the block chain to the fourth device; adding the fourth device as a node to the block chain; receiving a request to establish contract rules agreed upon by users of the first device, second device, and third device; establishing a contract between the users of the first device, second device, and third device; generating a transaction log associated with the contract; disbanding the local network; uploading the transaction log to a banking service provider; and executing the transaction log across banking accounts of users of the first device, second device, and third device.

According to another embodiment, a non-transitory computer readable medium may comprise instructions that when executed by one or more processors cause the one or more processors to: establish a network connection between a first device and a second device; establish a network connection between a third device and one or more of the first device and second device; configure a local network in communication with the first device, second device, and third device; establish a block chain between the first device, second device, and third device, wherein each of the first device, second device, and third device are nodes of the block chain; transmit a message from the first device to the second device and the third device; store in the block chain the message between the first device, second device, and third device; disband the local network; and upload the block chain to a cloud repository. The non-transitory computer readable medium may further comprise instructions to: connect a fourth device to the local network; download the message stored to the block chain to the fourth device; add the fourth device as a node to the block chain; receive a request to establish contract rules agreed upon by users of the first device, second device, and third device; establish a contract between the users of the first device, second device, and third device; generate a transaction log associated with the contract; disband the local network; uploading the transaction log to a banking service provider; and execute the transaction log across banking accounts of users of the first device, second device, and third device.

According to another embodiment, a system for an ephemeral dynamically linked mesh network may comprise one or more processors configured to: establish a network connection between a first device and a second device; establish a network connection between a third device and one or more of the first device and second device; configure a local network in communication with the first device, second device, and third device; establish a block chain between the first device, second device, and third device, wherein each of the first device, second device, and third device are nodes of the block chain; transmit a message from the first device to the second device and the third device; store in the block chain the message between the first device, second device, and third device; disband the local network; and upload the block chain to a cloud repository.

### BRIEF DESCRIPTION OF THE DRAWINGS

A full and enabling disclosure is set forth more particularly in the remainder of the specification. The specification makes reference to the following appended figures.

FIG. 1A-1B show an illustrative example of establishing the ephemeral dynamically linked mesh network and block chain.

FIG. 2 illustrates a flow chart for a method of operating an ephemeral dynamically linked mesh network.

FIG. 3 illustrates a flow chart for a method of adding an additional device to the ephemeral dynamically linked mesh network.

FIG. 4 illustrates a flow chart for a method of conducting transactions on the ephemeral dynamically linked mesh network.

FIG. 5 shows an illustrative example of uploading and downloading information related to the block chain of the ephemeral dynamically linked mesh network.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Block Chain Technology

Block chain technology allows for secure decentralized computing devices to store information such as transactions and messages on a distributed digital ledger. The digital ledger comprises data structures referred to as blocks on which users may store information. Block chain technology relies on computing devices, referred to as nodes, that store the digital ledger in memory, and authenticate the digital ledger's accuracy. The nodes authenticate the digital ledger's accuracy by executing consensus protocols, which are algorithms to verify that the nodes agree to add blocks to the block chain and verify that the blocks are consistent across copies of the block chain. The consensus protocols provide security to the block chain by requiring that a majority of nodes agree to add a block to the block chain. Consensus protocols also provide security to the block chain by requiring that a majority of nodes agree to manipulate information stored in blocks of the block chain.

Computing devices generate blocks using a hashing function in a process referred to as hashing. Hashing functions are algorithms that produce a unique output, referred to as hash values, based on inputs to the algorithm. The inputs to the hashing algorithm may include information, such as the messages and transactions, stored on the block, as well as the time and date of hashing.

The computing devices link the hashed blocks by adding a hash value of a preceding block to the hashed block. Because hash values are particular to a block, and the computing devices add the hash value of the preceding block to the next hashed block, the computing devices maintain a chain of blocks (the block chain) organized based on when the computing devices hashed the blocks.

### Illustrative Embodiment of an Ephemeral Dynamically Linked Mesh Network

In one illustrative embodiment, an ephemeral dynamically linked mesh network comprises an application executed on a computing system for communicating with other users and preserving communications in an accurate record by establishing a local mesh network that directly connects user devices via a local network connection.

The application may establish a first local connection between a first user and a second user when the application detects the first user and second user are within a predetermined threshold range. When the application detects a third user within a predetermined threshold range, the application may automatically establish a mesh network. The application uses the wireless technologies of user devices, such as WiFi and Bluetooth, to establish a local network connection between devices.

When the application establishes a mesh network, the application generates a block chain to store the communications between users of the mesh network. The individual user devices operate as nodes of the block chain and store a copy of the block chain locally at the user device. The individual user devices maintain accuracy of the block chain by executing consensus protocols. For example, the user devices may execute the consensus protocol automatically by comparing the distributed ledger of the blockchains stored at the user devices to other user devices of the mesh network. When the distributed ledgers of the majority of user devices match, the consensus protocol may require user devices storing non-matching distributed ledgers to update the locally stored distributed ledger to match the majority's distributed ledger. The consensus protocol may differ based on user settings or based on the content of the distributed ledger. For example, transactions recorded in the distributed ledger may require a super majority of over 50% such as 60% or 75% match of user devices in the mesh network to update the distributed ledger for transactions.

The application may disband the mesh network when the mesh network includes two or fewer devices within the predetermined threshold range. In some examples, users may manually select to disband the network. When the application disbands the mesh network, the application may upload the block chains saved on the user device to cloud service provider infrastructure, such as to a cloud repository. When the user devices do not have access to the internet, the user devices may store the block chain locally and upload the block chain when the user device gains access to the internet.

### Illustrative Example of Establishing a Mesh Network and Block Chain

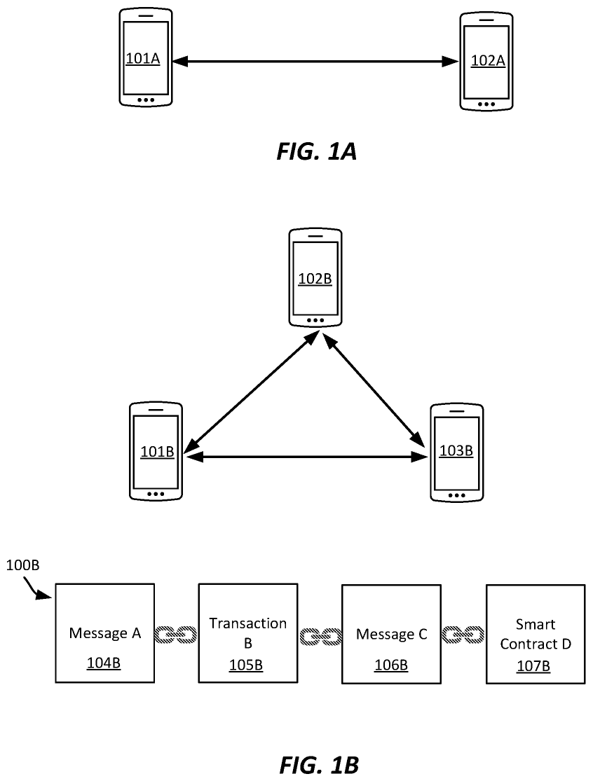

FIG. 1A illustrates the application establishing a local network between a first device 101A and a second device 102A. The application establishes the local network of the first device and second device by connecting the devices directly using wireless technology. For example, first device 101A and second device 102A may connect directly using Bluetooth. When connected directly, the first device 101A and second device 102A may transmit messages directly without requiring internet access. The application may establish the local network regardless of internet access availability and transmit messages directly without using internet access. In some examples, the local network may also allow the users to establish a video or voice call between devices.

The first device 101A, second device 102A, and third device 103A may establish a local network that uses multiple wireless technologies. For example, if first device 101A and the second device 102A include Bluetooth and WiFi capabilities, while the third device 103A only includes Bluetooth capabilities, the first and second devices 101A 102A may connect through WiFi and connect to the third device 103A through Bluetooth.

FIG. 1B illustrates the application establishing a mesh network between a first device 101B, a second device 102B, and a third device 103B. When the application establishes the mesh network, the application sets up a block chain 100B. 100B illustrates a block chain including blocks 104B, 105B, 106B, and 107B. Blocks of the block chain 100B are data structures configured to store information. By way of example, block chain 100B includes message A at block 104B and message C at block 106B. Message A and message C may include text messages, voice messages, photographs, videos, and GPS coordinates. The blocks of block chain 100B also include transactional information such as transaction B at block 105B. Transactional information may include a record of virtual currency exchanged between devices 101B 102B and 103B as well as descriptions of transactions. The blocks may also include terms of a smart contract such as smart contract D at block 107B.

### Illustrative Ephemeral Dynamically Linked Mesh Network

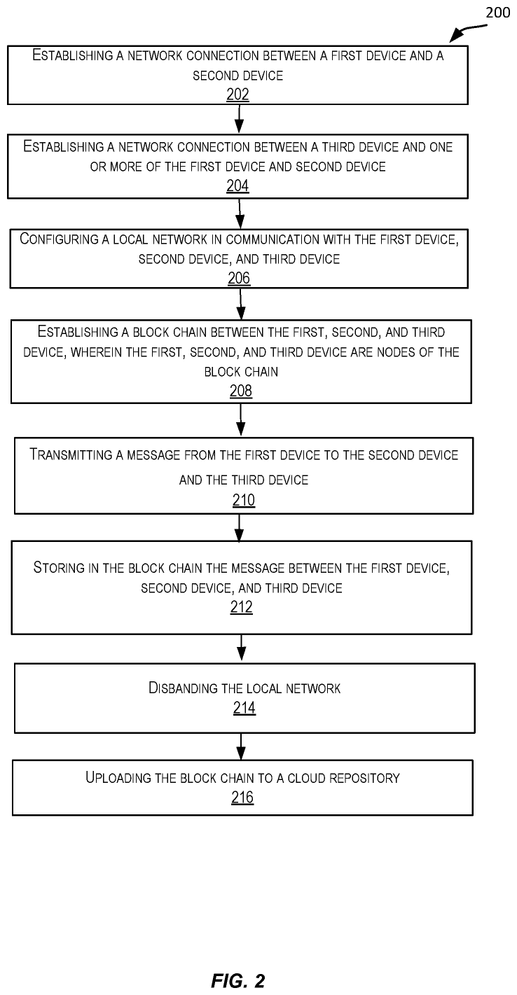

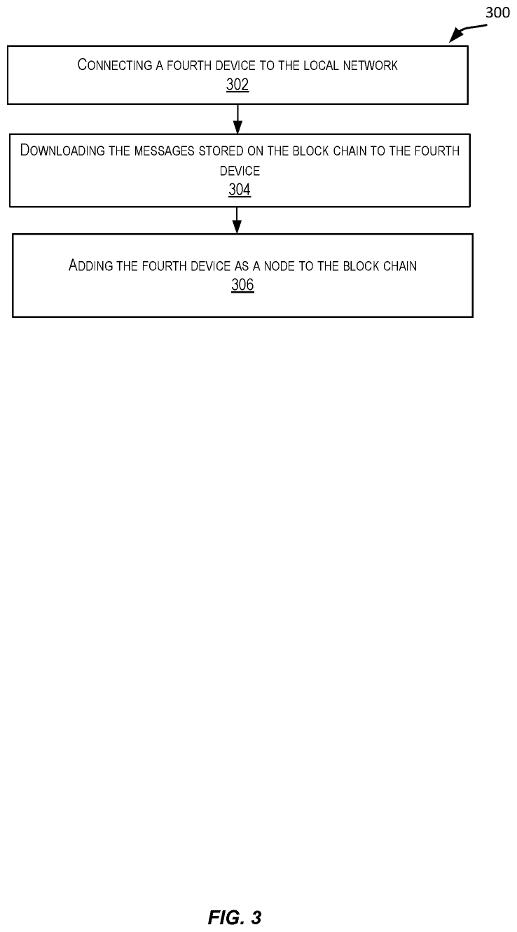

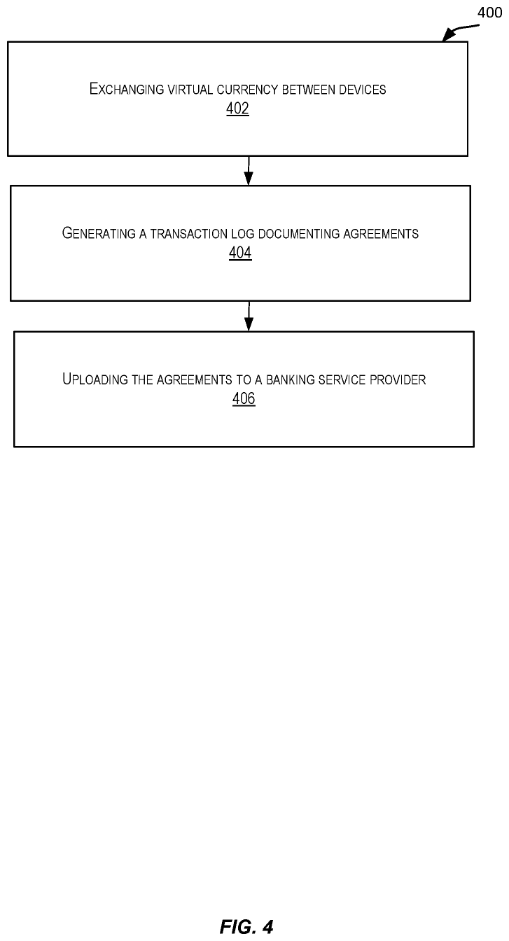

FIG. 2, FIG. 3, and FIG. 4 are flowcharts showing illustrative methods 200, 300, and 400 for operation of an ephemerally dynamically linked mesh network. In some embodiments, a processor, for example, the processor in a general-purpose computer, mobile device, or server, may execute some of the steps in flow charts of FIGS. 2, 3, and 4. In some embodiments, a group of processors may implement these steps. In some embodiments, one or more processors may perform the steps shown in FIGS. 2, 3, and 4 in a different order or may skip one or more steps. Alternatively, in some embodiments, the one or more processors may perform additional steps not shown in FIGS. 2, 3, and 4.

Method 200 begins with step 202 when the application establishes a network connection between a first device and a second device. The first device and second device are computing devices such as a cell phone, laptop, and tablet. The application establishes a network connection between the first device and the second device using wireless technology, such as by using built in hardware of the devices or peripherals of the devices. For example, when the devices include Bluetooth capabilities, the application may connect the devices through Bluetooth. The application may connect user devices using other wireless technology including WiFi, RF, 3g, 4g, and 5g technology. The application may also connect user devices using various wireless protocols such as IEEE Standard 802.11(be), 802.11(ax), 802.11(ac), and 802.11(n) over various frequencies including 2.4 GHz, 5 GHZ, and 6 GHz.

Method 200 continues to step 204 when the application establishes a network connection between a third device and one or more of the first device and second device. The application may check that the first device and second device include the third device in a whitelist preset by the user or application. When the users or the application whitelists the third device, the application may connect the third device to one or more of the first device and second device.

Users may establish the preset whitelist based on user preferences. For example, the users may select other users to add to the preset whitelist from a database of user information. In other examples, users may add other users to the preset whitelist from the contacts on the user's device. The application may identify contact information and past communications such as phone numbers, email addresses, mailing addresses, exchanged texts, phone call history, and emails stored in memory at the user's device to provide recommendations for adding users to the preset whitelist. For example, the application may compare the contact information between a first user and a second user, and identify that the first and second user have exchanged texts in the past. From the exchanged texts, the application may determine that the first user and the second user are acquainted, and recommend the first and second user add each other to his or her respective whitelist.

In further examples, when two users come within a predetermined threshold range, the application may notify the two users, and the two users may add each other to a whitelist. The application may notify the two users through a message on the users' device with options to add users to a whitelist. When the two users add each other to the whitelist, the application may automatically establish a local connection between the devices of the users when the users are within a predetermined threshold range.

In other examples, the application may establish a blacklist automatically for the users instead of or in addition to a whitelist. For example, when users report abusive or illegal activities from a user, the application may add the reported user to a blacklist to prevent the reported user from joining a mesh network.

In some examples the application may use the whitelist of a particular user's device. For example, the application may establish that the user of the first device to join the local network has the authority to determine whether to allow other devices to connect to the local network, or to remove and add devices from the local network.

The application may require devices pass an authentication protocol to connect with other devices. Users may adjust settings in the application to allow only particular users or user devices to connect to other devices. In one embodiment, the application may include a whitelist or blacklist to list users and devices that the application allows or bans from connecting to the local network. The authentication protocol may include comparing the user device and user to the list of whitelisted or blacklisted devices and users to determine to allow a device to connect with other devices. In one embodiment, the application may require that devices include a camera to scan the user's face to verify user identity and determine whether the application whitelisted or blacklisted the user. In such an embodiment, the application may compare the scan of the user's face to facial images stored by the application to verify the user's identity. When the user's face scan substantially matches the facial images stored by the application, the application may connect the user's device to the mesh network.

In step 206, the application configures a local network in communication with the first device, second device, and third device. The application may connect the first device, second device, and third device directly so that the first device connects to both the second device and third device, and the second device also connects to the third device. In other examples, the first device may connect to both the second device and the third device, and the second device may communicate to the third device with the first device as an intermediary, forming a chain of communication.

In one embodiment, the application may establish a local mesh network automatically as user devices come within a predetermined threshold range of at least two other user devices. The predetermined threshold range is a distance (e.g., five meters) set by the application or user. The application may include a whitelist to filter user devices and allow whitelisted users to automatically connect to the mesh network. For example, the user may specify users and devices allowed to join a particular local mesh network or may specify users and devices not allowed to join a particular local mesh network. The application may connect user devices automatically when the user devices come within the predetermined threshold range of at least two other user devices. Users may adjust the predetermined threshold range, or the application may set the predetermined threshold range based on range limitations of the user device. For example, the application may set the predetermined threshold range for user devices that connect through Bluetooth to a shorter distance and may set the predetermined threshold range for user devices with RF capabilities to a longer distance to substantially match the technical requirements of the different wireless technologies. For example, when the user device uses Bluetooth technology, the application may set the predetermined threshold range to thirty feet, whereas when the user device uses WiFi technology, the predetermined threshold range may extend to three hundred feet. Other wireless technology, such as RF may set the predetermined threshold range further, such as at 20 miles or more.

In step 208, the application establishes a block chain between the first, second, and third device. The application may establish the block chain with the first device, second device, and third device as individual nodes of the block chain. As nodes of the block chain, the first device, second device, and third device store copies of the distributed ledger of the block chain and execute consensus protocols to maintain the accuracy of the ledger. Consensus protocols may include comparing distributed ledgers of the block chain saved at the first device, second device, and third device. When a majority of devices have matching distributed ledgers, or matching portions of the distributed ledger, the application may determine the majority block chain as accurate and update the other block chains based on the majority determined distributed ledger.

In some embodiments, the mesh network may support more than three devices. As the applications adds additional devices to the mesh network, the application may add the additional devices as nodes to the block chain.

In some examples, the application may establish the block chain on one device. For example, the application may establish the block chain on the first device. The first device may run one or more virtual machines to represent the second device and third device, and store multiple copies of the block chain at memory locations associated with the one or more virtual machines. The virtual machines running on the first device may serve as nodes of the block chain and may execute consensus protocols on behalf of the second device and third device. In such an embodiment, when the application adds more devices to the mesh network, the application may add more virtual machines to the first device to represent the added devices.

In other examples, the initial device to connect to another device may execute additional actions as an initiator device, such as breaking ties in consensus protocols. For example, when there are an even number of devices connected in the mesh network and half of the devices indicate a difference in the block chain not present in the block chain of the other half of the devices, the initiator device may determine the correct block chain. The application may execute the initiator action automatically, such as by automatically determining to defer to the initiator device's block chain during ties in consensus protocol. When the application defers to the initiator device's block chain, the application may update the block chain of other users with a copy of the initiator device's block chain. In other examples, the application may transmit a message to notify the initiator of inconsistencies between block chains and of a tie in the consensus protocol. The application may request that the initiator break the tie by deciding which block chain is accurate. When the initiator selects a block chain as accurate, the application may replace the inconsistent block chains with a copy of the selected block chain.

In step 210, the application transmits a message from the first device to the second device and the third device. The message may include text, photographs, and videos, as well as transaction requests and payments. The description of FIG. 4 further describes an example of a payment system using a mesh network according to the present disclosure. The application may also transmit other information such as coordinate information of connected devices. For example, when the first device, second device, and third device include GPS technology, the application may send GPS coordinates associated with the first, second, and third devices to each other when within the predetermined threshold range. The application may send the GPS coordinates upon request or may stream the GPS coordinates between the devices.

In some examples, the application may use the GPS coordinates to warn users when the user is nearly outside of the predetermined threshold range. In further examples, the application may determine that the user is nearly outside of the predetermined threshold range based on signal strength of the connection between the user's device and the other devices on the local network. The application may measure the signal strength based on Received Signal Strength Indicators (RSSI). For example, the Received Signal Strength Indicators (RSSI) may be based on the amount of power received from the signal connection of devices, such as measurements of signal power in decibel-milliwatts. In further examples, the Received Signal Strength Indicators (RSSI) may represent signal path loss in measurements of decibels per meter. When the Received Signal Strength Indicators (RSSI) fall outside of a predetermined range, the application may determine that the user is at risk of losing connection, and the application may send a warning to the user to move closer to other users.

In step 212, the application stores information related to the messages between the first device, second device, and third device in the block chain. Individual blocks of the block chain may represent messages of users. For example, the application may store an individual text at a block in the block chain. As the devices send communications, the application hashes additional blocks on the block chain including the messages.

For example, the application may hash an additional block for additional communications such as hashing an additional block for an additional message. Data related to the message may serve as an input to the hashing function. In some examples, the hashing functions includes time and date of hashing as inputs to the hashing function. The hashing function generates a hash value based on the inputs of the hashing function particular to the inputs. Because the hash value is particular to the inputs, the hash value represents a unique location of the block on the block chain. The application, may add the hash value of the previous block to the newest block to indicate the order of the blocks on the block chain, linking the blocks. The first device, second device, and third device store the values of the hashes and data related to the blocks of the block chain.

In step 214, the application disbands the local network between the first device, second device, and third device. The devices may initiate the disbanding of the local network by request, or users may leave the predetermined threshold range to remove the devices from the local network. When users leave the predetermined threshold range, such that only two devices remain connected or no devices remain connected, the application may disband the local network automatically. In some examples, when the application determines that a device loses connection to the local network, the application may suspend changes to the block chain until the device reconnects to the local network.

In step 216, the application uploads the block chain to a cloud repository. The first device, second device, and third device may upload the block chain individually to a cloud repository when the devices gain access to the internet. The application may store the block chain locally in memory of the devices until the devices reconnect to the internet.

In some examples, the devices may execute a consensus protocol to verify that the block chains of the individual devices are consistent, and then upload a single copy of the block chain to a cloud repository. The application may choose the device that uploads the copy to the cloud repository based on a variety of factors including battery life, connection speed to the internet, and available storage. In other examples, the application may choose the initiator device to upload the block chain.

### Illustrative Example of Adding an Additional Device to the Mesh Network

Method 300 begins with step 302 when the application adds a fourth device to the local network. In one embodiment, the application adds the fourth device to the local network when the fourth device is within the predetermined threshold range of other devices connected to the local network. Other embodiments may include an authentication protocol for determining the identity of users before adding users to the local network. For example, when the fourth device is within the predetermined threshold range of other devices, the application may notify the user of the fourth device through a message prompt. The prompt may request a password to join the other devices in the local network and require additional proof of identity from the fourth device, such as requiring a facial scan. In some examples, the devices connected to the local network may vote on whether to add the fourth device to the local network, or the user of the initiator device may add the fourth device to the local network. In further examples, the application may automatically establish a network connection between the fourth device and other devices based on preset whitelists of the other devices. For example, when a majority of the other devices include the fourth device on a preset whitelist, the application may automatically establish a network connection between the fourth device and the other devices.

In step 304, the application determines through a consensus protocol the messages stored in the nodes of the block chain. For example, the consensus protocol may include comparing the messages stored at a block on the block chain of the first device, second device, and third device to verify the consistency of the block chain. When the consensus protocol determines a consistent block chain across a majority of the devices, the application may update inconsistent block chains to match the majority's consistent block chain.

In step 306, the application downloads the messages stored on the block chain to the fourth device. The application may download the messages from the initiator device. In other examples, the application may download the messages stored on the block chain from the closest device, or from the device with a stronger signal connection to the fourth device. In other examples, the first device, second device, or third device may include near field communication technology (NFC) and may initiate downloading the messages stored on the block chain by tapping the fourth device.

In step 308, the application adds the fourth device as a node to the block chain. As a node to the block chain, the fourth device stores a copy of the block chain and executes the consensus protocol. In some examples, such as when the nodes of the block chain are virtual machines established by a first device, the application may establish a virtual machine on the first device representing the fourth device.

In some embodiments, the application may add additional devices to the local network in addition to the fourth device. The application may determine through consensus protocol the messages stored in the block chain and download the messages stored on the block chain to additional devices. The application may also add additional devices as nodes to the block chain and the additional devices may store a copy of the block chain and execute the consensus protocol.

### Illustrative Example of Conducting a Transaction on the Mesh Network

Method 400 illustrates an example of the application conducting transactions on the ephemeral dynamically linked mesh network. Method 400 may occur at or between various steps of method 200. For example, method 400 may occur between step 208 and step 216.

Method 400 begins at step 402 by exchanging virtual currency between devices. The application may exchange the virtual currency based on contract rules established by the users who are parties to a transaction. For example, the contract rules may include dividing payment for a good or service between multiple users. The application may automatically exchange virtual currency between parties to the transaction according to the contract rules.

In some examples, the application may execute the contract rules when prompted by a trigger condition. Trigger conditions may include receiving input from parties to a transaction, receiving input from a neutral third-party overseeing a transaction, or receiving information from a sensor associated with a device. For example, the parties to the transaction may provide input to the application indicating that the transaction is complete causing the application to exchange virtual currency according to the contract rules.

In another example, a measurement by a user's device may fulfill a trigger condition. For example, the application may use location measurements, such as GPS location, as a trigger condition. In one such example, users may agree to pay a driver to drive the users to a drop off location. The application may detect the users arriving at the drop off location based on the GPS coordinates of the user devices and exchange virtual currency according to the contract rules.

In step 404 the application generates a transaction log documenting the exchange of the virtual currency and other agreements, such as records of executed and pending transactions, contract rules, and personal information associated with parties to transactions including names, addresses, and account routing numbers. The application may store the transaction log at a block in the block chain and display the transaction log to users in a user interface. The application may update the transaction log in real time or near real time as users enter into contracts. Further, the application may encrypt information in the transaction log to protect personal information.

In step 406 the application uploads the agreements to a banking service provider. The banking service provider may execute the agreements by exchanging the virtual currency for real-world currency or transferring real-world currency between user accounts according to the transaction log. In some examples, the virtual currency exchanged by the application may have a set value proportional to real-world currencies, such as US Dollar (USD), European Euro (EUR), or Japanese Yen (JPY). For example, the application may determine that one unit of the virtual currency is equivalent to one US Dollar. When connected to the internet, the application may monitor a user's bank account balance and adjust the amount of virtual currency available to a user based on the bank account balance. When the user loses connection to the internet, the application may set the virtual currency available to the user at the last known bank account balance of the user or at a proportion of the last known bank account balance of the user. The user may use the virtual currency from the application for transactions while the application is not connected to the internet.

Illustrative Example of Uploading and Downloading the Block Chain from Cloud Service Provider (CSP) Infrastructure

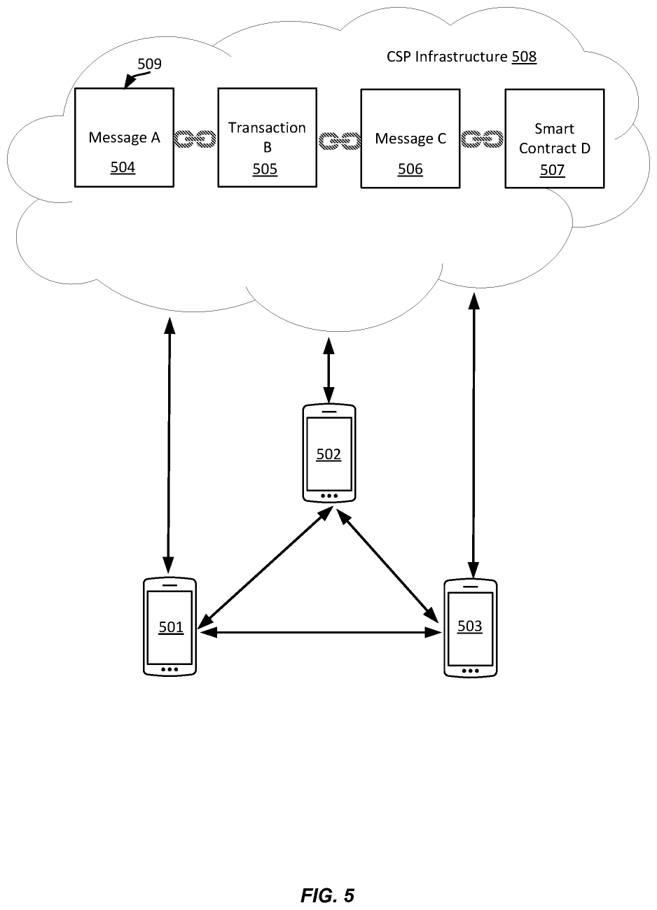

FIG. 5 illustrates an example of the ephemeral dynamically linked mesh network uploading and downloading information related to the block chain from cloud service provider (CSP) infrastructure 508.

FIG. 5 illustrates a first device 501, second device 502, and third device 503 connected in a mesh network, and connected to cloud service provider (CSP) infrastructure 508. The cloud service provider (CSP) infrastructure 508 may include various servers or databases. FIG. 5 illustrates a single cloud service provider (CSP) infrastructure 508 shared by the first device 501, second device 502, and third device 503. In other examples, the first device 501, second device 502, and third device 503 may connect to separate cloud service provider (CSP) infrastructure 508 and upload copies of the block chain 509. The description of FIG. 1B further describes the block chain 509.

The cloud service provider (CSP) infrastructure 508 may store individual copies of the block chain for each device part of the mesh network. In other examples, the first device 501, second device 502, and third device 503 may execute a consensus protocol and upload the block chain resulting from the consensus protocol.

### Advantages and Examples of the Ephemeral Dynamically Linked Network

There are numerous advantages of the ephemeral dynamically linked network. For example, the ephemeral dynamically linked network allows for users to make secure transactions on devices without requiring connection to the internet. For example, in situations such as at auctions, oftentimes large numbers of people gather in a location to conduct transactions. Auction houses may lack the infrastructure to provide a reliable internet connection to everyone in attendance. Especially for auctions with high priced items, paying in cash limits the buyers to only spending what the buyer has brought, and sellers generally are wary of accepting checks to avoid fraud. Further, using credit cards generally requires added hardware such as a card reader and connection to credit card infrastructure to transact, which may be unavailable in locations without phone lines or internet access. The application allows for users to transact securely even without connection to the internet.

The application also allows first responders to communicate securely in locations without access to internet or cell service. For example, forest officers and park rangers may use the application to communicate with one another while in the wilderness, or to send alerts to hikers and campers in the park within the predetermined threshold range. Other forest workers may also use the application to facilitate transactions between users in the park without access to the internet or cell service.

The ephemeral dynamically linked network also protects user privacy by preventing internet service providers (ISPs) from accessing user messages. Because the application sends messages from one user device to another user device without an internet service provider or cell service provider, the internet service provider and cell service providers do not have access to the messages sent between users. Further, in some examples, the application may encrypt the messages stored at the blocks of the block chain. The application may encrypt the messages prior to uploading the block chain to a cloud repository or the application may forego uploading the block chain to a cloud repository and store the block chain locally.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random-access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, which may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method comprising:
establishing a network connection between a first device and a second device;
establishing a network connection between a third device and one or more of the first device and second device;
configuring a local network in communication with the first device, second device, and third device;
establishing a block chain between the first device, second device, and third device, wherein each of the first device, second device, and third device are nodes of the block chain;
transmitting a message from the first device to the second device and the third device;
storing in the block chain the message between the first device, second device, and third device;
disbanding the local network; and
uploading the block chain to a cloud repository.

2. The method of claim 1, further comprising:
connecting a fourth device to the local network;
downloading the message stored to the block chain to the fourth device; and
adding the fourth device as a node to the block chain.

3. The method of claim 1, further comprising:
receiving a request to establish contract rules agreed upon by users of the first device, second device, and third device;
establishing a contract between the users of the first device, second device, and third device; and
generating a transaction log associated with the contract.

4. The method of claim 3, further comprising:
disbanding the local network;
uploading the transaction log to a banking service provider; and
executing the transaction log across banking accounts of users of the first device, second device, and third device.

5. The method of claim 4, wherein the first device and the second device exchange virtual currency based on the contract rules.

6. The method of claim 3, further comprising:
determining whether the contract rules are satisfied based on a trigger measured by the first device, second device, and third device.

7. The method of claim 1, wherein the first device has authority over the second device and third device to remove the second device or third device from the local network.

8. The method of claim 1, wherein the network connection between the first device and the second device is established automatically when the first device and second device are within a predetermined threshold distance.

9. The method of claim 1, wherein the first device, second device, and third device join the local network based on a preset whitelist.

10. The method of claim 9, wherein the preset whitelist includes a repository of facial images associated with one or more users of the first device, second device, and third device, wherein the network connection of the first device, second device, and third device is based on a comparison of facial images of the preset whitelist to facial images of the one or more users of the first device, second device, and third device.

11. The method of claim 1, wherein the first device and the second device are connected locally by one or more wireless technologies selected from the group consisting of: Bluetooth, WiFi, 3g, 4g, and 5g.

12. The method of claim 1, further comprising:
detecting that one of the first device, second device, or third device loses connection to the local network; and
suspending changes to the block chain until the first device, second device, or third device reestablish connection to the local network.

13. A non-transitory computer readable medium comprising instructions that when executed by one or more processors cause the one or more processors to:
establish a network connection between a first device and a second device;
establish a network connection between a third device and one or more of the first device and second device;
configure a local network in communication with the first device, second device, and third device;
establish a block chain between the first device, second device, and third device, wherein each of the first device, second device, and third device are nodes of the block chain;
transmit a message from the first device to the second device and the third device;
store in the block chain the message between the first device, second device, and third device;
disband the local network; and
upload the block chain to a cloud repository.

14. The non-transitory computer readable medium of claim 13 further comprising:
add a fourth device to the local network;
determine through a consensus protocol the message stored in the nodes of the block chain;
download the message stored to the block chain to the fourth device; and
add the fourth device as a node to the block chain.

15. The non-transitory computer readable medium of claim 13 further comprising:
receive a request to establish smart contract rules agreed upon by two or more of the first device, second device, and third device;
establish a smart contract; and
generate a transaction log documenting transactional agreements.

16. The non-transitory computer readable medium of claim 15, wherein upon disbanding the local network, the transaction log is uploaded to a banking service provider and executed across banking accounts of users of the first device, second device, and third device.

17. The non-transitory computer readable medium of claim 16, wherein the first device and the second device exchange virtual currency.

18. The non-transitory computer readable medium of claim 15, wherein a determination of whether the smart contract rules are satisfied is based on a trigger, wherein the trigger is determined by one or more of the first device, second device, and third device, and the trigger is a value measured by one or more of the first device, second device, and third device.

19. The non-transitory computer readable medium of claim 13, wherein the first device has authority over the second device and third device to remove the second device or third device from the local network.

20. A system comprising:
one or more processors configured to:
establish a network connection between a first device and a second device;
establish a network connection between a third device and one or more of the first device and second device;
configure a local network in communication with the first device, second device, and third device;
establish a block chain between the first device, second device, and third device, wherein each of the first device, second device, and third device are nodes of the block chain;
transmit a message from the first device to the second device and the third device;
store in the block chain the message between the first device, second device, and third device;
disband the local network; and
upload the block chain to a cloud repository.
